(19) United States
(12) Patent Application Publication
(10) Pub. No.: US 2007/0081239 A1
(43) Pub. Date: Apr. 12, 2007

(54) Optical characteristics of a screen

(76) Inventors: Gregory J. May, Corvallis, OR (US); William J. Allen, Corvallis, OR (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 11/244,537

(22) Filed: Oct. 6, 2005

(51) Int. Cl. G03B 21/56

(52) U.S. Cl. 359/443

(57) ABSTRACT

Embodiments of adjusting an optical characteristic of one or more sections of a screen are disclosed.

### BACKGROUND

Typical projection systems may provide images that are less desirable than those provided by other projection systems. For example, when a projection system is used in an environment with ambient light (such as a bright room), projected images may be displayed with an undesirably low contrast. Hence, current projection implementations may provide inappropriate results when used in the presence of ambient light.

### BRIEF DESCRIPTION OF DRAWINGS

The detailed description is described with reference to the accompanying figures. In the figures, the left-most digit(s) of a reference number identifies the figure in which the reference number first appears. The use of the same reference numbers in different figures indicates similar or identical items.

FIG. 1 illustrates a block diagram of an embodiment of a front projection system, according to an embodiment.

FIG. 2 shows a front view of an embodiment of a screen that includes a plurality of sections, according to an embodiment.

FIG. 3 shows a sample image, according to an embodiment.

FIG. 4 illustrates an embodiment of a response by screen.

FIG. 5 is a flow diagram of an embodiment of a method, according to an embodiment.

FIG. 6 illustrates a sample transfer function adjustment graph, according to an embodiment.

FIGS. 7-10 illustrate sample graphs of screen reflectivity versus time and color wheel sections of a projector, according to various embodiments.

### DETAILED DESCRIPTION

Various embodiments for modifying a characteristic, such as an optical characteristic, of a screen are described. In one embodiment, an optical characteristic of one or more sections of a screen are independently modified. The optical characteristic that is modified may be the screen's reflectivity and/or absorbance. For example, projected image quality can be enhanced by determining a difference between data for images that are to be displayed with data for images in a database to determine the appropriate screen sections to darken and the appropriate amount of darkening, e.g., in coordination with projected image intensity. Upon controlling a section of the screen to drop to a less reflective state, the modulation of light at the bit level within the projector provides for increased resolution control over the intensity (or power) of the light in the image projected on the screen, allowing the screen to provide a more dynamic range in dark zones of the image and increase the ability of the projector to present finer intensity steps. This may also reduce the effects of ambient lighting on the screen.

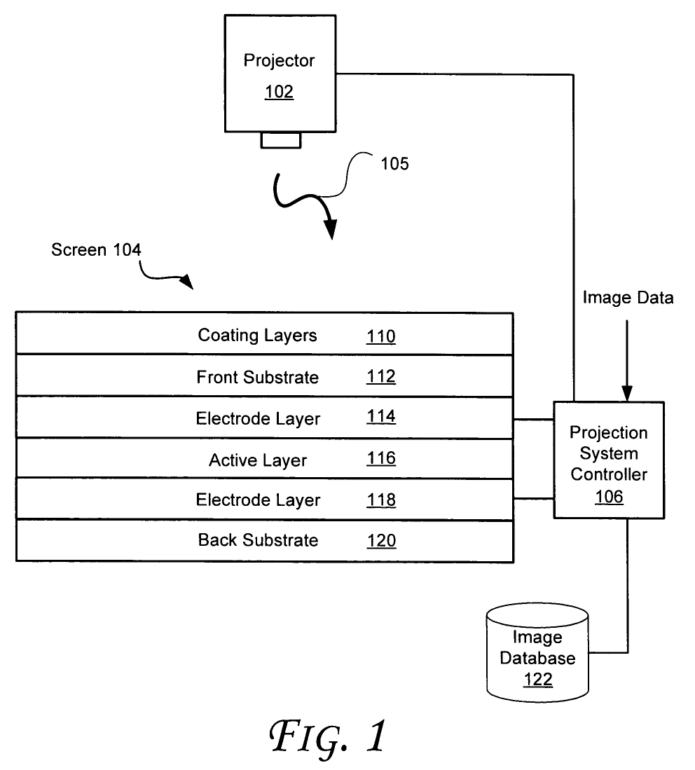

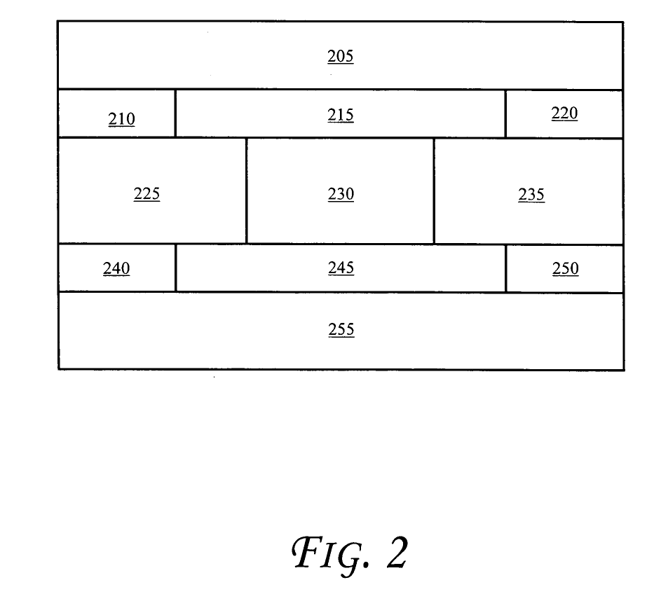

FIG. 1 illustrates a block diagram of an embodiment of a front projection system 100, according to an embodiment. The front projection system 100 includes a projector 102 to project images on an embodiment of a screen, such as a screen 104. The projector 102 may provide visible and/or non-visible light (105) as will be further discussed herein. The screen 104 may be a suitable projection screen such as a rear projection screen or a front projection screen. As illustrated in FIG. 1, the screen 104 may be coupled to a projection system controller 106. The projection system controller 106 may coordinate the operation of the projector 102 and the screen 104. Also, the projection system controller 106 may trigger or reset the response of the screen 104 (e.g., during issues with synchronization timing, image projection, and the like), provide and/or condition a power supply (e.g., providing electrical power to the screen 104), and/or establish the timing of a screen reset. The projector 102 may be any suitable digital projector such as a liquid crystal display (LCD) projector, a digital light processing (DLP) projector, and the like. Moreover, even though FIG. 1 illustrates a front projection system (100), the techniques discussed herein may be applied to a rear projection system. For example in a rear projection screen system, the transmissiveness of the screen may be modified. As shown in FIG. 1, image data (input video signal for example) may be received by the controller 106 and passed along to the projector 102. In an embodiment, the image data may be modified depending on the reflectivity values utilized for the screen regions discussed herein, e.g., with reference to FIGS. 2-4. Also, the controller 106 may be implemented inside the projector 102, or the image data may be sent to the screen 104 and projector 102 that may each have a separate controller.

The screen 104 may be a projection screen with at least one section that is capable of providing a modifiable optical characteristic, e.g., that is capable of assuming multiple reflectivity and/or absorbance states. The multiple reflectivity and/or absorbance states may provide a higher contrast ratio in the presence of ambient light and/or a color projected on the screen 104 by the projector 102 than would otherwise be obtained, as is further discussed herein. In one embodiment, the projector 102 outputs some light, even in its OFF state. The ratio of a highest light intensity or light power output achievable for an embodiment of projector 102 used to a lowest light intensity or light power output (from the embodiment of the projector 102 used) is the contrast ratio and it characterizes the dynamic range of the embodiment of projector (102). Also, the screen 104 may be utilized to lower the luminance of the projected image by lowering the screen reflectivity (or increasing the screen absorbance). If there is no detectable ambient light (e.g., by an unaided human eye), the contrast ratio of the system 100 is the product of the contrast ratios of the projector 102 and of the screen 104.

Additionally, ambient light image artifacts may be at least partially suppressed in an embodiment. For example, if the reflectivity of a patch of the screen 104 is 25% of the highest achievable reflectivity of the embodiment of screen 104 used, then that patch reflects ¼ as much ambient light to the viewer's eyes. The image luminance contribution from the projector 102 is also cut by a factor of 4. As long as the projector 102 is bright enough (i.e., the light output of projector 102 is of sufficient intensity or power) to reproduce the image for detection by an unaided human eye, e.g., in spite of the screen's reduced reflectance, the image brightness may have about ¼ as much influence from ambient light. As a result, the contrast ratio of the environment (projector 102 in a particular set of viewing conditions) may be increased.

As illustrated in FIG. 1, the screen 104 may include one or more coating layers 110, a front substrate 112, an electrode layer 114, an active layer 116, an electrode layer 118, and a back substrate 120. The coating layers 110 may be one or more layers deposited on the front substrate 112 that may include an antireflective layer such as a suitable anti-glare surface treatment, an ambient rejection layer such as a plurality of optical band pass filters, one or more micro-lenses, and/or a diffuse layer. The front substrate 112 may be an optically clear and flexible material such as Polyethylene Terephthalate (PET or PETE) on which the coating layers 110 are formed. The electrode layer 114 may be formed on the bottom surface of the front substrate 112.

The electrode layer 114 may be one or more suitable transparent conductors such as Indium Tin Oxide (ITO) or Polyethylene Dioxythiophene (PEDOT). In one embodiment, the electrode layer 114 may form the top conductor(s) of the active layer 116.

The active layer 116 may be an optically and/or electrically active layer that responds to the application of light or voltage across itself with a change in its absorbance and/or reflectivity. A number of different active layers 116 may provide such a response. One example includes a polymer dispersed liquid crystal (PDLC) layer in which pockets of liquid crystal material are dispersed throughout a transparent polymer layer. In an embodiment, the active layer 116 may be a continuous dichroic-doped PDLC layer that scatters light (appears white or milky) in color under a no voltage condition and becomes transparent when a voltage is applied across it. In combination with a light absorbing back substrate 120, the screen 104 can be changed along the continuum from light to dark by modulating the voltage across the electrode layers 114 and 118. In an embodiment, an infra-red (IR) or ultra-violet (UV) sensor may be used to sense non-visible light from the projector 102 and signal the active layer 116 to activate and/or change states. The IR (or UV) sensor may be located at any suitable location to receive the light from the projector 102, such as around the periphery of the screen 104. In some embodiments, a chemical coating or thin film layer of electrochromic material, such as Tungsten Oxide, or photochromic material, across which an electric field may be selectively applied, may serve as the active layer 116. The application of a bias across such an electrochromic material active layer (116) may enable the screen 104 to switch from white to gray or white to clear, in which case a gray or black backer may be included. Such an embodiment may include an ITO array type of conductive layer 114 on the front or top of the screen 104 and a second conductive layer (118) on the opposite side of the active layer near the back layer.

In an embodiment, the electrode layer 118 may be similar to the electrode layer 114 and be positioned on the back substrate 120. An opposite charge may be applied to the electrode layer 118 (e.g., relative to the charge applied to the electrode layer 114). Similarly, the back substrate 120 may be similar to the front substrate 112 in material composition but different in its position at the bottom of the stack of the screen 104, and its relatively darker color (or white if the active material is black in the non-energized state). In one embodiment, the projection system controller 106 selectively applies a voltage across the active layer 116 via the application of opposite charges to the electrode layers 114 and 118. The selective application of the voltage across the active layer 116 may enable the adjustment of the optical characteristic of the screen (104) over time and/or for a plurality of sections of the screen (104).

In an embodiment, light (105) is projected from the projector 102 and impinges upon the screen 104. The coating layers 110 may serve to reduce specular reflection both in the visible and/or non-visible range from the screen 104 by implementing an antireflection coating. The coating layers 110 may also serve to absorb and/or deflect a portion of the ambient light that may be generated by extraneous sources other than the projector 102, e.g., by implementing an ambient rejection coating. The coating layers 110 allow a portion of the light incident upon its surface to pass through (partially diffuse) to the layers underlying the coating layers 110.

In one embodiment, the screen 104 may include white and clear modes (referring to modes of active layer 116), where clear mode provides a view of the black/dark back layer (e.g., 120). Alternatively, the screen 104 may include black and clear modes, e.g., the active layer (116) is dyed black or dark gray for absorbance purposes. In this case, a highly reflective back layer (120) may be utilized, rather than a black layer. There are a host of techniques that may be utilized to build the screen 102. For example, technologies for electronic paper are suitable, as are liquid crystal displays (LCDs).

In some embodiments, the screen 104 may be modular and sectioned into a plurality of pixels, the size of which may or may not match the resolution of the projector 102. Such a front projection system (100) may provide enhanced image contrast by selectively changing the reflectance and/or absorbance of either the entirety of the screen 104 and/or sections of the screen 104 coordinated with the projected image. The front projection system 100 therefore may create relatively deeper black by changing the color of the screen (104) from white to black. Under ambient light conditions, such a system (100) may produce a contrast ratio that may be the multiplicative product of the inherent contrast ratio of the projector 104 and the contrast change made by the screen 104.

Furthermore, in an embodiment, the front projection system 100 may provide reduction of contrast loss due to ambient light contamination. As the contrast ratio of the screen 104 may be the greatest achievable reflectivity (or absorbance) for the embodiment of the screen 104 used divided by the lowest achievable reflectivity (or absorbance) for the embodiment of the screen 104 used, and the contrast ratio of the front projection system 100 may be approximately the multiplicative product of the contrast ratio of the projector 102 in a bright room setting and the contrast ratio of the screen 104, the provision of the screen 104 having a modest 5:1 contrast ratio in certain settings may provide a relatively high perceived reduction in ambient light to the projected image.

FIG. 2 shows a front view of an embodiment of a screen 200 that includes a plurality of sections 205, 210, 215, 220, 225, 230, 235, 240, 245, 250, and 255, according to an embodiment. Screen 200 may be similar to the screen 104 of FIG. 1. Sections 205, 210, 215, 220, 225, 230, 235, 240, 245, 250, and 255 are independently addressable sections of screen 200 in which reflectivity (or absorbance) can be controlled.

In operation, the reflectivity of screen 200 is controlled in multiple independent sections of screen 200 by designating a plurality of sections, in an embodiment, eleven sections 205 through 255. The strategic choice of a small number of sections 205 through 255 enables multiple sections of screen 200 to change reflectivity independently with a manageable amount of data processing to allow contrast enhancements to occur in a cost effective system. The strategic choice and arrangement of sections is not limited to the example shown in FIG. 2 but may be embodied in a range of appropriate selections. The inclusion of more sections provides higher image quality but may increase data processing. Appropriate selection and arrangement of sections takes advantage of the inclusion of more sections near the center of projection screen 200 to provide better image quality with a relatively low increase in data processing overhead. On the other hand, if the screen 104 has more sections than the projector 102 has pixels, the overall system resolution may be mostly determined by the screen resolution. So if screen sections are, relative to projector pixels, inexpensive, then a relatively high resolution screen 104 may be utilized.

Also, an embodiment takes advantage of the fact that a strategic arrangement of sections, such as sections 205 through 255, can match (such as be sufficiently similar) with the contents of a large number of common images. For example, many projected images contain an object or person in the center of the image, with a dark horizontal region below the object and a lighter horizontal region above the object. Arrangements of sections on screen 200, in which to dynamically control reflectivity (or absorbance), may allow a relatively simple system to produce significant increases in image quality.

Projection system controller 106 analyzes a stream of data corresponding to an image that is to be displayed on screen 200. Projection system controller 106 determines what the greatest power for the projected light is to be for the brightest pixel (pixels providing the greatest reflected light intensity) in each section 205 through 255 for a given image. From this brightest pixel determination, projection system controller 106 determines the appropriate reflectivity response for each section 205 through 255. In one embodiment, the count of the brightest n pixels for each section 205 through 255 is determined. This subset of pixels may be discarded (or ignored) by applying a filter and the brightest pixel (i.e., the pixel that would be reflecting the greatest projected light power) determined from the remaining pixels. By removing the subset of pixels from the data of the image to be projected before comparison with the data for the store images, this may reduce the likelihood of small bright spots in the image from affecting the reflectivity determination in an undesired manner. The reflectivity for a given section is thus the percentage of the greatest power for the light that is to be projected for the brightest pixels determined by projection system controller 106. A threshold number may be predetermined to establish a level to identify the brightest pixels. The projected power output may be changed by the reflectivity of the viewing surface by multiplying by 1/R (where R is the reflectivity of that section of the viewing surface, expressed as a percentage of the highest achievable reflectivity of the viewing surface—100 equal 100%) for all pixels in the given section. For example, projection system controller 106 may determine that the number of pixels which are identified to be the ones with the highest intensity in section 255 is a small fraction of the brightest attainable pixel intensity and thus determines that it is appropriate to drop the reflectivity of section 255 to a low reflectivity state, while the quantity of the brightest pixels in section 205 is a large percentage of the total number of attainable pixels and thus determines that it is appropriate to control the reflectivity of section 205 to be at or near a 100 percent reflectivity state. Other techniques may also be employed. For example, an algorithm where the majority of the samples favors one or another screen reflectivity setting may be employed In an alternate embodiment, a database (122) of stored images (or data) may be coupled to or included within projection system controller 106 that may or may not include a look-up table. Projection system controller 106 compares data for images that are to be displayed on screen 200 with data for images included in the database (122). Upon finding a sufficient degree of similarity between a stored image within the database and the image to be projected, a corresponding look-up table may be used to determine the appropriate reflectivity response for sections 205 through 255. In the case where a sufficient degree of similarity cannot be found between the data for a stored image within the database (122) and the data for the image to be projected, screen 200 may controlled, in one embodiment, to perform in a default mode, in which sections 205 through 255 remain in a 100% reflective (white) state.

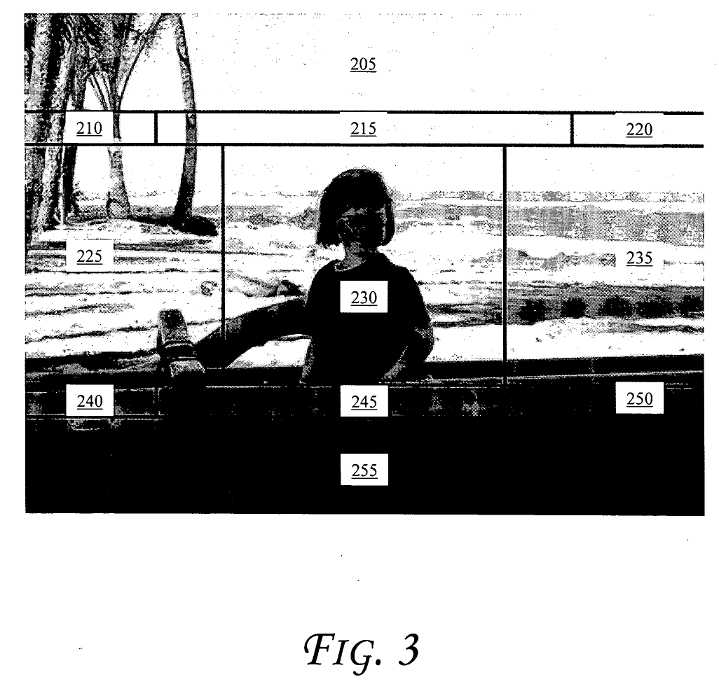

FIG. 3 shows a sample image 300 in which a girl appears near the center of the image with a dark section near the bottom of the image and a lighter section near the top of the image, according to an embodiment. FIG. 3 also illustrates the sections 205 through 255 of FIG. 2 superimposed on the image 300 for illustrative purposes.

In an embodiment, determinations (such as calculations) are made for the reflectivity of each section 205 through 255 by projection system controller 106, e.g., by determining the brightest pixels for each section 205 through 255, as described above. Projection system controller 106 determines if a reflectivity change is appropriate for each section 205 through 255 and the degree of change in reflectivity for each section 205 through 255 to provide greater image quality.

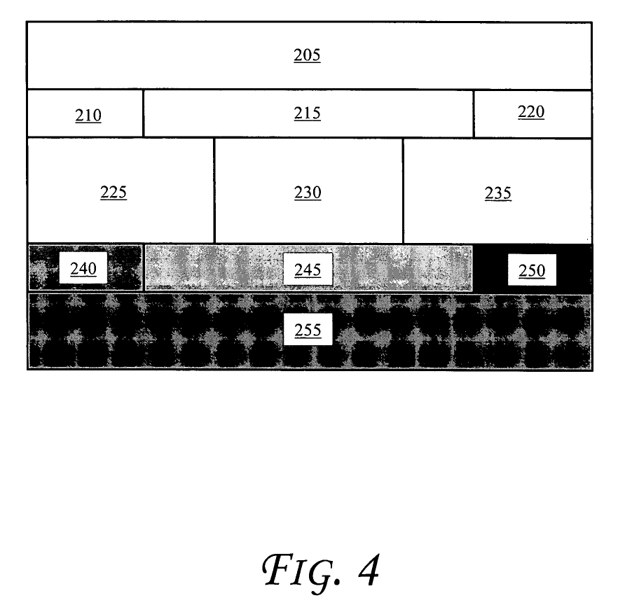

FIG. 4 illustrates an embodiment of a response by screen 200 of FIG. 2 in which sections 205 through 235 remain 100% reflective (white) while sections 240 through 255 each drop to a lesser reflectivity (or absorbance) state. Alternatively, data for image 300 of FIG. 3 can be compared to the data for images included in a database 122 of FIG. 1. If projection system controller 106 of FIG. 1 determines that an image to projected is sufficiently similar to a stored image (where sufficiently similar indicates a fit of the data to a range and may include a tolerance to allow for some flexibility and viewer desires for the image characteristics) between image 300 and an image within its database (122), in an embodiment, a look-up table may be employed that includes the appropriate reflectivity response for sections 205 through 255. If it is determined that the image to be projected is not sufficiently similar to any of the stored images, screen 200 remains in a default state in which all sections 205 through 255 remain in a 100% reflective state, for example. Hence, FIG. 4 illustrates an appropriate response of screen 200 to increase the projected image quality of image 300.

Moreover, in one embodiment, sufficiently similar may include a bit-perfect pixel for pixel match between the image 300 and an image stored within the database 122. More generally, a match may imply some degree of sameness between the images that are determined to be a match. A very large number of algorithms could be employed, with degrees of tradeoffs, in determining matches and deciding how and what form of data to store. In one embodiment, the database 122 may store data for images that are formed by removing through filtering pixel values for each section having the greatest values. A metric (perhaps root-mean-square (RMS) error for all regions) may be applied and the nearest reference image may then be identified as the match. If the RMS error for the nearest reference image exceeds a threshold, then a “no match” situation may be declared, and the default screen values imposed as discussed herein. Also, a cascading set of less rigorous match criteria and/or database entries may be used until a fallback match is selected. In another embodiment, other information may be utilized during the matching process (e.g., regardless of the resolution of the screen sections). For example, information about spatial frequency, overall distribution (e.g., histogram) of pixel values, number of edges, motion information (e.g., if the image is a sequence from video), and so forth. All this data may be taken into account when finding a “match” or determining whether images are sufficiently similar.

Furthermore, by dropping the reflectivity of screen 200 in sections in which darker image portions are present, in the illustrated example, sections 240 through 255, a higher quality image is displayed in which contrast enhancements are apparent and the modulation of light at the bit level within projector 205 provides finer impacts on screen 200, allowing shadow details to become apparent that otherwise may be very difficult to achieve or even unachievable by some projection systems (e.g., 8-bit versus 16-bit systems).

In an embodiment, the effects of image brightness gradients at the edges of bordering sections may be reduced. For example, in reference to FIG. 4, sections 250 and 235 may be characterized by a large reflectivity difference, as are sections 245 and 230, and sections 240 and 225. In an embodiment, the reflectivity of certain pixels (thereby affecting the brightness perceived for the pixels) within sections near the borders of relatively high reflectivity difference sections may be gradually increased such that the effect of ambient light is reduced at the boundary between sections with relatively high reflectivity differences and/or reduce visible transition impacts between these sections. Alternatively, the reflectivity of certain pixels within sections near the borders of lower reflectivity difference sections may be gradually decreased to achieve a similar effect.

The table below provides sample response of screen 200 shown in FIG. 4 to increase the projected image quality of image 300, according to an embodiment. The greatest intensity illustrated is after a degamma technique is applied to the image. As shown in table 1, the intensity may be in the range of 0, to 255, linear. The screen reflectivity value may be the percent of the greatest reflectivity the particular embodiment of screen (104) used is capable of attaining.

TABLE 1
Sample Intensity and Reflectivity Values for Sections

| | Max Intensity (R, G, or B) | Screen |
|---|---|---|
| Section | After Degamma | Reflectivity |
| 205 | 255 | 100% |
| 210 | 255 | 100% |
| 215 | 255 | 100% |
| 220 | 255 | 100% |
| 225 | 255 | 100% |
| 230 | 255 | 100% |
| 235 | 255 | 100% |
| 240 | 148 | 58% |
| 245 | 162 | 64% |
| 250 | 85 | 33% |
| 255 | 139 | 55% |

In a further embodiment, a desired user setting may determine how the reflectivity (or absorbance) of the screen 200 is changed for each of the sections 205-255. In an embodiment, tone reproduction may be adjusted in coordination with changes in the screen's reflectivity. In one embodiment, three factors that affect how an imaging system is adjusted are: image content, desired user settings, and/or viewing conditions. Viewing conditions includes ambient light, how reflective the room and screen are, position of the screen, what boarder it has, and so on. For example, a different set of reflectivity (or absorbance) settings may be selected (that are different than nominal values) based on any of the above. Alternatively, look-up tables may be utilized for different factors indicated above. Also, the values read from the table may be adjusted algorithmically based on the three factors before applying them.

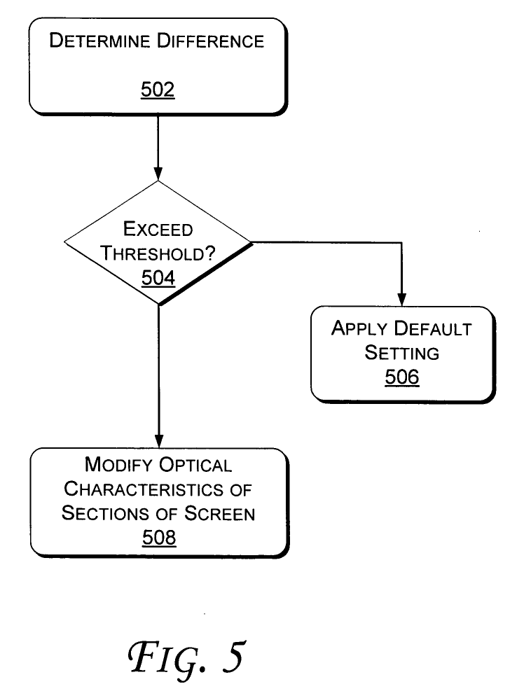

FIG. 5 is a flow diagram of an embodiment of a method 500, according to an embodiment. At an operation 502, the method 500 determines the difference between data corresponding to an image to be projected on a screen (104) and data corresponding to one or more sections of the screen (104) (such as the sections discussed with reference to FIGS. 2-4). Determining the difference (502) may include searching a database (122) that stores one or more images and their characteristics, e.g., to select the data corresponding to the one or more sections (such as the sections discussed with reference to FIGS. 2-4).

At operation 504, if it is determined that the difference exceeds a threshold, an operation 506 applies a default optical characteristic setting to the one or more sections (such as the sections discussed with reference to FIGS. 2-4). Otherwise, if the operation 504 determines that the difference does not exceed a threshold, an optical characteristic of the one or more sections (such as the sections discussed with reference to FIGS. 2-4) may be modified at an operation 508 in accordance with the difference (502). In one embodiment, the operation 508 may include modifying the optical characteristic of one or more pixels forming each of the sections. Additionally, the reflectivity of select pixels within a section of the one or more sections may be changed to form a reflectivity gradient, so that the reflectivity of the select pixels decreases with increasing distance from a border with a higher reflectivity section. Alternatively, the reflectivity of select pixels within a section of the one or more sections may be changed to form a reflectivity gradient so that the reflectivity of the select pixels increases with increasing distance from a border with a lower reflectivity section.

In a further embodiment, the method 500 may determine a subset of the data corresponding to ones of a plurality of pixels included in the screen to be illuminated by light having an intensity greater than a threshold from the image to be projected in the one or more sections. For example, determining the difference may include comparing the data for the image to be projected, excluding the subset of the data, to the data corresponding to the one or more sections of the screen. In a yet another embodiment, light may be modulated at a bit level within a projector (102) to provide for adjustment of light power in the image to be projected on a screen (104). In various embodiments, the optical characteristic may be selected based on one or more of an image content, a user selected parameter, or viewing conditions.

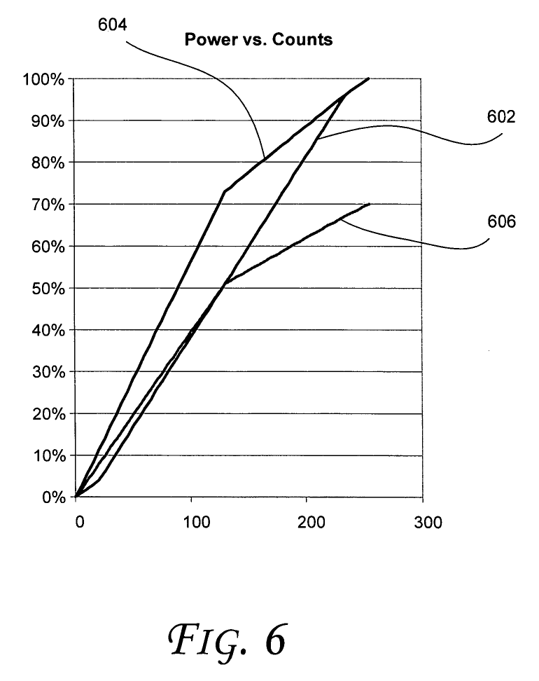

FIG. 6 illustrates a sample transfer function adjustment graph 600, according to an embodiment. In an embodiment the graph 600 illustrates several transfer functions of the relative reflected power of light from a screen or projected light onto the screen (expressed as a percentage of input count of projected power or reflected power (i.e. 0-255), respectively, of light for an embodiment of the projector and screen used) versus the counts of bits of projection intensity (e.g., 255 steps) (255 being the greatest in this example). Line 602 is a classic Sygmoid transfer function which compresses highlights and shadows of an image to gain some contrast in mid tones. The configuration of line 602 may be used with a normal image and 100% reflective screen.

In FIG. 6, line 604 illustrates a projection (PJ) transfer function for use when a relatively low key image (e.g., where average intensity is 75 counts) is identified. In such an embodiment, the screen may be set to 70% reflectance. Line 606 corresponds to the reflected power resulting from the projection transfer function of line 604 curve on a screen with 75% reflectance. With 130 counts into the system and an output of 180/255 of total power output, the contrast may be increased. Highlights (e.g., anything above 130 counts) are significantly clipped, e.g., resulting in reduction of contrast increase, which may be appropriate for a darker scene or section of an image.

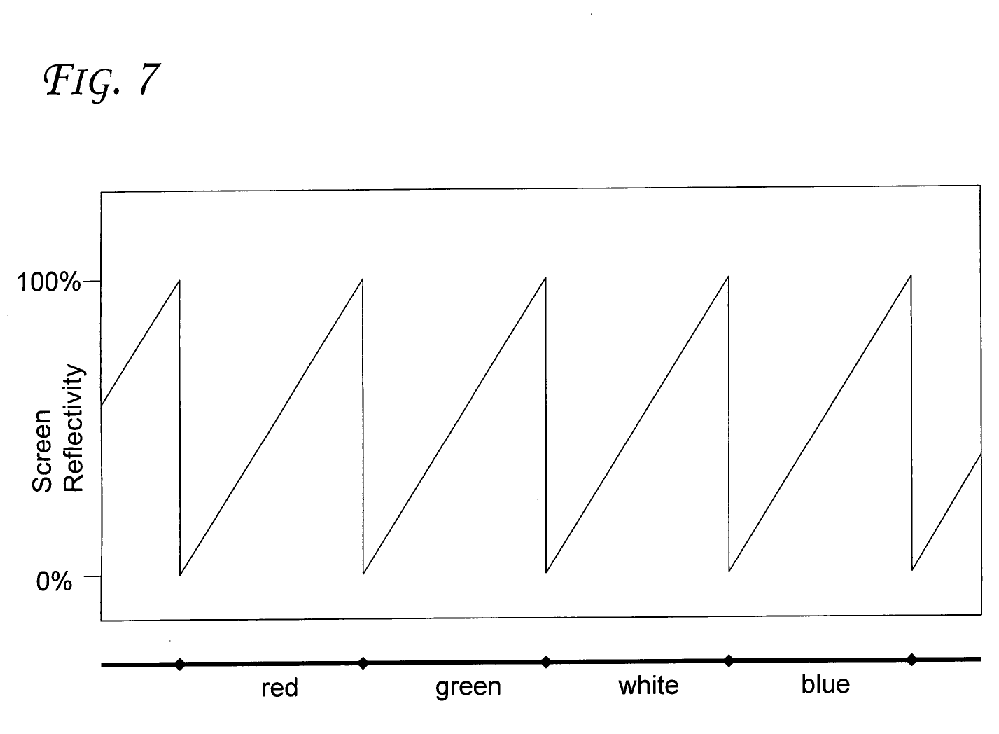

FIG. 7 illustrates a sample graph 700 of screen reflectivity versus time and color wheel sections of a projector (e.g., the projector 102 of FIG. 1), according to an embodiment. As illustrated by graph 700, screen reflectivity may slew during each wheel section type and have a fast reset. PDLC (Polymer Doped Liquid Crystal) may respond in a fashion similar to that shown by graph 700, e.g., where PDLC responds relatively quickly to an electrical field but is relatively slow to return to its relaxed (or steady-state) state.

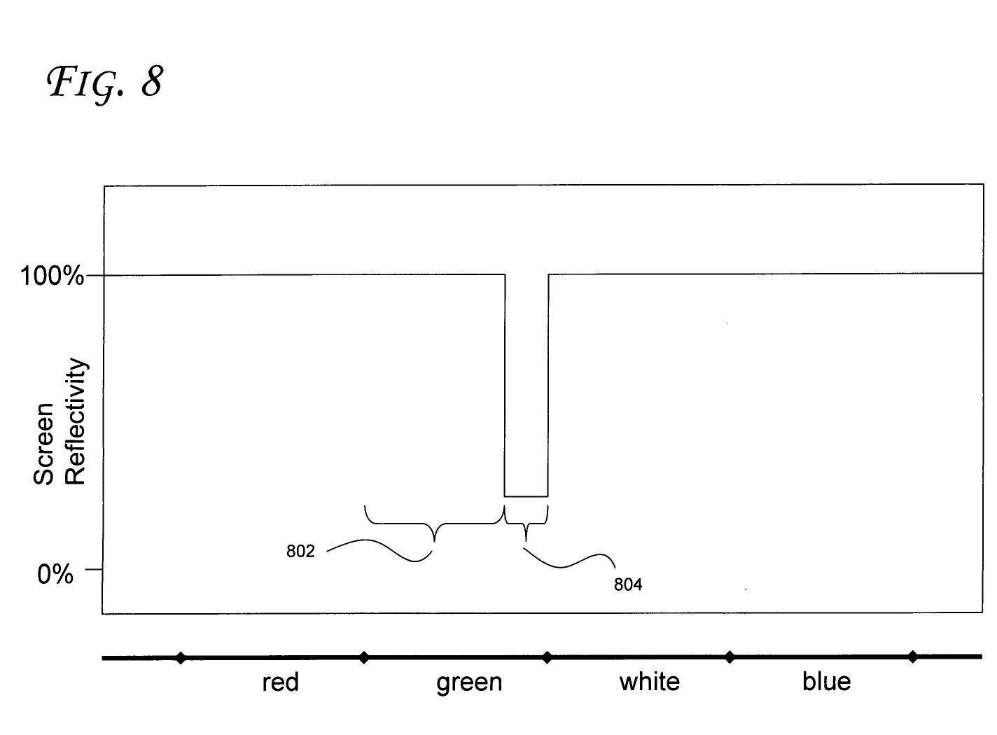

FIG. 8 illustrates a sample graph 800 of screen reflectivity versus color wheel sections of a projector (e.g., the projector 102 of FIG. 1), according to an embodiment. As illustrated by graph 800, screen reflectivity may change during some wheel section types to generate virtual “dark” sections. This would be similar to providing a second set of darker color segments but instead of providing actual darker sections, the screen reflectivity can be changed to reduce the resulting intensity. For example, after the ordinary green wheel section (802), the screen reflectivity may be reduced to provide a virtual dark green wheel section (804). The darker sections may be use to implement smaller intensity steps by reducing the intensity for each change in light intensity from the modulator. This technique may also be applied to each screen section discussed with reference to FIGS. 2- 4.

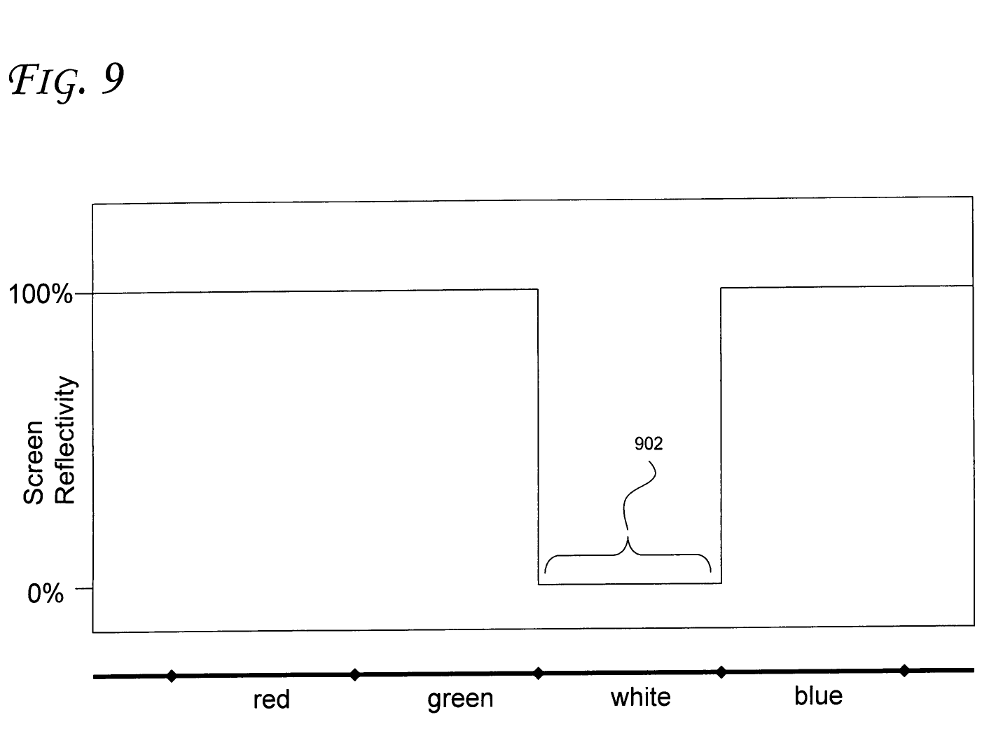

FIG. 9 illustrates a sample graph 900 of screen reflectivity versus color wheel sections of a projector (e.g., the projector 102 of FIG. 1), according to an embodiment. As illustrated in FIG. 9, the screen may be turned off if the white wheel section is not being used for video mode, e.g., to decrease ambient influence and boost contrast. For example, an unused white wheel section 902 is illustrated in FIG. 9 during which the screen is switched off, e.g., to reduce ambient influence. By reducing the reflectivity of the screen, the effect is to also reduce the effects of ambient on the screen and image contrast as noted earlier.

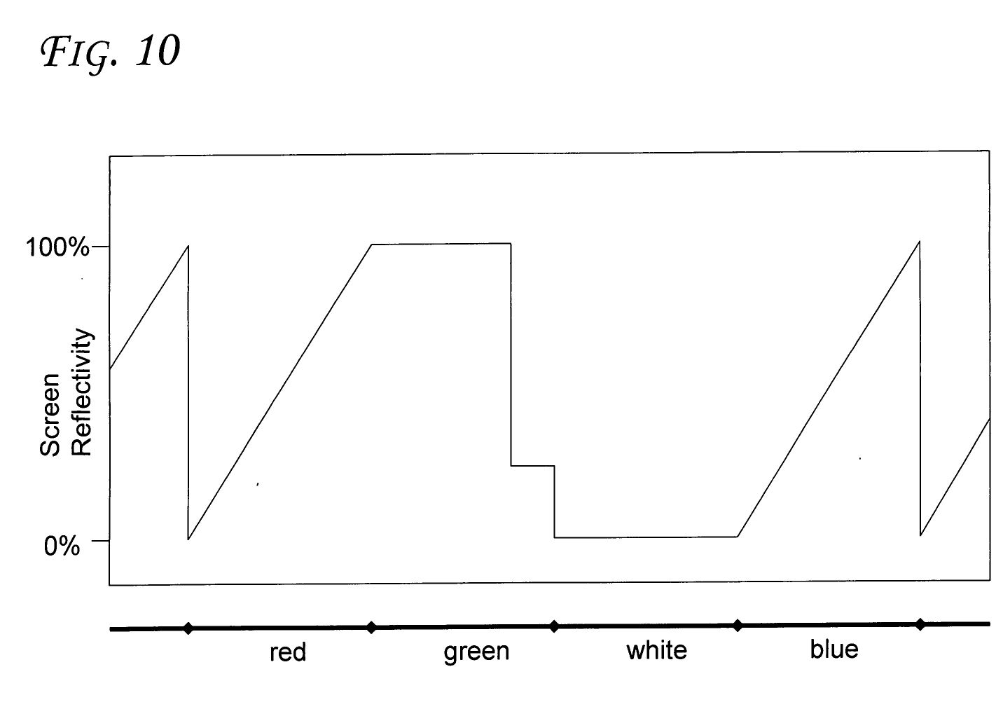

FIG. 10 illustrates a sample graph 1000 of screen reflectivity versus color wheel sections of a projector (e.g., the projector 102 of FIG. 1), according to an embodiment. The graph 1000 illustrates that changes in screen reflectivity may be mix and matched, as long as the projected image is adjusted accordingly, i.e., the screen reflectivity is included in the calculation to predict the resulting image intensity. The screen reflectivity during each color segment can be unique to each segment.

In one embodiment, the systems 100 FIG. 1 may include one or more processor(s) (e.g., microprocessors, controllers, etc.) to process various instructions to control the operation of the screen (104), the projector (102), and/or the projection system controller (106). The system 100 may also include a memory (such as read-only memory (ROM) and/or random-access memory (RAM)), a disk drive , a floppy disk drive, and a compact disk read-only memory (CD-ROM) and/or digital video disk (DVD) drive, which may provide data storage mechanisms the processors.

One or more application program(s) and an operating system may also be utilized which may be stored in non-volatile memory and executed on the processor(s) discussed above to provide a runtime environment in which the application program(s) may run or execute.

Some embodiments discussed herein (such as those discussed with reference to FIGS. 1-10) may include various operations. These operations may be performed by hardware components or may be embodied in machine-executable instructions, which may be in turn utilized to cause a general-purpose or special-purpose processor, or logic circuits programmed with the instructions to perform the operations. Alternatively, the operations may be performed by a combination of hardware and software.

Moreover, some embodiments may be provided as computer program products, which may include a machine-readable or computer-readable medium having stored thereon instructions used to program a computer (or other electronic devices) to perform a process discussed herein. The machine-readable medium may include, but is not limited to, floppy diskettes, hard disk, optical disks, CD-ROMs, and magneto-optical disks, ROMs, RAMs, erasable programmable ROMs (EPROMs), electrically EPROMs (EEPROMs), magnetic or optical cards, flash memory, or other suitable types of media or machine-readable media suitable for storing electronic instructions and/or data. Moreover, data discussed herein may be stored in a single database, multiple databases, or otherwise in select forms (such as in a table).

Additionally, some embodiments discussed herein may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment is included in at least an implementation. The appearances of the phrase “in one embodiment” in various places in the specification may or may not be all referring to the same embodiment.

Thus, although embodiments have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
determining a difference between data for an image to be projected on a screen and data corresponding to one or more sections of the screen; and
modifying an optical characteristic of the one or more sections in accordance with the difference.

2. The method of claim 1, wherein the determining the difference includes searching a database storing a plurality of images and their characteristics to select the data corresponding to the one or more sections.

3. The method of claim 1, wherein modifying the optical characteristic of each of the one or more sections comprises modifying an optical characteristic of one or more pixels forming each of the sections.

4. The method of claim 1, wherein modifying the optical characteristic comprises modifying a screen reflectivity or a screen absorbance.

5. The method of claim 1, further comprising applying a default optical characteristic setting to the one or more sections if the difference exceeds a threshold.

6. The method of claim 1, further comprising changing a reflectivity of select pixels within a section of the one or more sections to form a reflectivity gradient so that the reflectivity of the select pixels decreases with increasing distance from a border with a higher reflectivity section.

7. The method of claim 1, further comprising changing a reflectivity of select pixels within a section of the one or more sections to form a reflectivity gradient so that the reflectivity of the select pixels increases with increasing distance from a border with a lower reflectivity section.

8. The method of claim 1, further comprising determining a subset of the data corresponding to ones of a plurality of pixels included in the screen to be illuminated by light having an intensity greater than a threshold from the image to be projected in the one or more sections;
wherein determining the difference includes comparing the data for the image to be projected, excluding the subset of the data, to the data corresponding to the one or more sections of the screen.

9. The method of claim 1, further comprising modulating light at a bit level within a projector to provide for adjustment of light power in the image to be projected.

10. The method of claim 1, further comprising selecting the optical characteristic based on one or more of an image content, a user selected parameter, or viewing conditions.

11. An apparatus comprising:
a controller configured to:
compare data for an image to be projected on a screen to data for a predetermined image; and
configured to adjust an optical characteristic of at least one of one or more sections of the screen using differences between the data for the image to be projected and the data for the predetermined image.

12. The apparatus of claim 11, wherein each of the one or more sections comprises a plurality of pixels.

13. The apparatus of claim 11, further comprising a image database to store data for one or more of the predetermined image.

14. A computer-readable medium comprising:
stored instructions to determine a difference between data for an image to be projected on a screen and data corresponding to one or more sections of the screen; and
stored instructions to modify an optical characteristic of the one or more sections in accordance with the difference.

15. The computer-readable medium of claim 14, further comprising stored instructions to select a set of optical characteristics based on one or more of an image content, a user selected parameter, or viewing conditions.

16. The computer-readable medium of claim 14, further comprising stored instructions to apply a default optical characteristic setting to the one or more sections if the projected image fails to match the known image.

17. The computer-readable medium of claim 14, further comprising stored instructions to gradually increase a brightness of select pixels within a section of the one or more sections near a border of higher reflectivity sections.

18. The computer-readable medium of claim 14, further comprising stored instructions to gradually decrease a brightness of select pixels within a section of the one or more sections near a border of lower reflectivity sections.

19. A system comprising:
means for determining if an image projected on a screen matches a stored image; and
means for modifying an optical characteristic of one or more sections of the screen in accordance with the matched image.

20. The system of claim 19, further comprising means for applying a default optical characteristic setting to the one or more sections if the projected image fails to match the stored image.

21. The system of claim 19, further comprising means for gradually increasing a brightness of select pixels within a section of the one or more sections near a border of higher reflectivity sections.

22. The system of claim 19, further comprising means for gradually decreasing a brightness of select pixels within a section of the one or more sections near a border of lower reflectivity sections.

23. The system of claim 19, further comprising means for determining a maximum intensity power for a brightest pixel in each section of the one or more sections.

24. The system of claim 19, further comprising means for modulating light at a bit level within a projector to provide a finer adjustment of the projected image.

25. The system of claim 19, further comprising means for selecting a set of optical characteristics based on one or more of an image content, a user selected parameter, or viewing conditions.
